(19) United States
(12) Patent Application Publication
(10) Pub. No.: US 2024/0349929 A1
(43) Pub. Date: Oct. 24, 2024

(54) PORTABLE COFFEE BREWING APPARATUS

(71) Applicants: Yigang LI, Guangzhou, GD (CN); Jicheng YAN, Foshan, GD (CN)

(72) Inventors: Yigang LI, Guangzhou (CN); Jicheng YAN, Guangzhou (CN)

(21) Appl. No.: 18/303,591

(22) Filed: Apr. 20, 2023

(51) Int. Cl. A47J 31/00; A47J 31/06; A47J 31/08; A47J 31/44; B65D 1/06; B65D 43/02; B65D 51/24; B65D 53/02; B65D 85/804

(52) U.S. Cl. CPC A47J 31/005; A47J 31/0689; A47J 31/085; A47J 31/4407; B65D 1/06; B65D 43/021; B65D 51/24; B65D 53/02; B65D 85/8046; B65D 85/8061; B65D 2251/205; B65D 2543/0062; B65D 2543/00731; B65D 2543/00972

(57) ABSTRACT

The present invention discloses a portable coffee brewing apparatus and a using method therefor, and belongs to the technical field of coffee brewing. The apparatus comprises an upper lid, a bottle body, a bottom lid, a pushing structure, and a powder cartridge, wherein two ends of the powder cartridge are provided with a first filtering device and a second filtering device with a permeability lower than that of the first filtering device, the pushing structure is configured to push the powder cartridge to move axially along the bottle body, and the upper lid and the bottom lid are in sealing connection with two ends of the bottle body in a detachable manner. The coffee brewing apparatus of the present invention adopts the second filtering device with a low permeability to filter, which is beneficial to pressurization and infiltration to improve the concentration of the coffee.

### TECHNICAL FIELD

The present invention relates to the technical field of coffee brewing, and in particular to a portable coffee brewing apparatus.

### BACKGROUND

Coffee is a common beverage that varies in flavor depending on the type of coffee bean, the extraction apparatus, and the brewing method. At present, the common coffee brewing method is the French press method, and the coffee brewing apparatus comprises an outer cup, a French press rod, and a powder cartridge provided with filter screens at two ends. When the coffee brewing apparatus is used, water is filled into the outer cup, coffee powder is filled into the powder cartridge, and then the powder cartridge is placed into the outer cup; and at this time, the peripheral sidewall of the powder cartridge is in sealing connection with the inner wall of the outer cup, and the French press rod pushes the powder cartridge to move in the outer cup, so that the coffee powder is soaked by the water. Since the soaking time has an important influence on the taste, the soaking time needs to be strictly controlled, and the powder cartridge is usually removed after being soaked for 4-8 minutes.

Two same metal filter screens are usually selected for the current powder cartridge, and the selected metal filter screens are generally large in pore size, so that the problem that part of coffee grounds enter the upper coffee liquid to influence the taste is present; and the pressure bearing of the water body at the lower part of the outer cup in the French press process is small, and the pressure of the water body contacting with and dissolving coffee is low, which is not beneficial to pressurization and infiltration to obtain strong coffee.

### SUMMARY

In view of the above problems, the objective of the present invention is to provide a portable coffee brewing apparatus, wherein one end of a powder cartridge adopts a second filtering device with a low permeability, so as to fully filter coffee grounds, and simultaneously, the pressure of the water body at the lower part of the outer cup in the French press process is also increased, so that strong coffee can be obtained.

In order to achieve the above technical objective, the present invention adopts the following technical solutions.

A portable coffee brewing apparatus comprises an upper lid, a bottle body, a bottom lid, a powder cartridge, and a pushing structure, wherein the bottle body is of a structure with openings at two ends, the upper lid and the bottom lid are in sealing connection with the two ends of the bottle body in a detachable manner, and a first container capable of containing water is formed after the connection; a second container capable of containing water is formed after one of the upper lid and the bottom lid is detached from the first container, and a third container capable of containing water is formed after the other one of the upper lid and the bottom lid is detached from the first container; the powder cartridge is configured to store coffee powder, two ends of the powder cartridge are provided with filtering devices which are a first filtering device and a second filtering device, and the second filtering device has a permeability lower than that of the first filtering device; the powder cartridge is capable of being placed in from an opening of the second container and taken out from an opening of the third container, and when the powder cartridge is positioned in the second container and the third container, the powder cartridge is in sealing connection with peripheral sidewalls of the second container and the third container; and the pushing structure is configured to push the powder cartridge to move in the second container, and the second filtering device is arranged downstream of the first filtering device in the process of placing the powder cartridge into the second container.

It is known that the brewing time (the time of the coffee powder contacting with the water) needs to be controlled in the coffee brewing process, and therefore, the powder cartridge needs to be taken out from the outer cup after a certain time. After this apparatus adopts the second filtering device with a small porosity, the resistance of the powder cartridge and the water during relative movement is very large, and it is almost impossible to take out and place the powder cartridge along the same opening of the second container, which will be specifically described below: it is relatively easy to place the powder cartridge into the second container, the front-back pressure difference of the second filtering device may be improved by the counterforce of the bottom part of the second container on the fluid below the powder cartridge, and the powder cartridge is pushed to move by large pressure; however, it is very difficult to take out the powder cartridge from the second container, at this time, the fluid above the powder cartridge is in normal pressure, this fluid seeps below the powder cartridge completely depending on its own gravity, and the fluid above the powder cartridge contains coffee with a high viscosity and a poor fluidity, therefore, it takes a long time and cannot meet the needs of real life; and in addition, when the powder cartridge is lift up, a negative pressure is formed below the powder cartridge, the higher the moving speed, the greater the negative pressure, and it is not easy to move quickly. Therefore, the upper lid and the bottom lid are designed to shorten the distance of the powder cartridge to be moved when the powder cartridge is taken out by a separable structure of the cup body.

As a specific embodiment of the present invention, the second filtering device is a filter paper, and the first filtering device is a filter screen.

As a specific embodiment of the present invention, the second filtering device is a dense metal filter screen, and the first filtering device is also a filter screen having pores larger than those of the second filtering device.

As a specific embodiment of the present invention, the pushing structure is connected with the powder cartridge in a detachable manner, the specific connection manner may be a threaded connection, also may be a snap connection, and further may be a soft rubber tight fit fixation, and certainly, in order to enhance the sealing, a sealing ring and the like may be further provided as needed.

The pushing structure may be a pressing rod, and the fluid on the upper part and the lower part of the powder cartridge is in contact with the inner wall of the outer cup, however, coffee ingredients are easy to precipitate on the inner wall of the outer cup to influence the sealing between the powder cartridge and the outer cup in the later period; therefore, the present invention provides a structure in which the inner wall of the outer cup is only in contact with water and not in contact with coffee ingredients; and as a specific embodiment of the present invention, the pushing structure is an inner cup, the inner cup is of a cylindrical structure with openings at two ends, one end of the inner cup is communicated with one end of the powder cartridge provided with the second filtering device, and the inner cup is in sliding and sealing connection with the inner peripheral sidewall of the outer cup.

As a specific embodiment of the present invention, the upper lid and the bottom lid need to be in sealing connection with the cup body, particularly, the upper lid or the bottom lid needs to bear higher pressure when the pushing structure pushes the powder cartridge to move, and the requirement on the sealing performance is higher at the moment, therefore, the present invention provides a novel sealing structure with strong performance; and specifically, the sealing structure comprises a first cylinder section and a second cylinder section which are cylindrical, the inner wall of one end of the first cylinder section is coaxially connected with the outer wall of one end of the second cylinder section threadedly, end surfaces of opposite ends of both the first cylinder section and the second cylinder section are provided with annular grooves and bosses, and the grooves are matched with the bosses, so that the bosses are inserted into and in pressing contact with the grooves after the first cylinder section and the second cylinder section are connected.

Further, the grooves are provided with sealing gaskets.

As a specific embodiment of the present invention, the powder cartridge comprises a cylindrical cartridge body and a pressing lid, and the pressing lid is connected with one end of the cartridge body in a detachable manner, which is convenient for placing coffee powder into the body and taking out coffee grounds.

Further, one end of the pressing lid is provided with a sieve plate configured to support the second filtering device, and the flow area of the sieve plate is larger than the cross-sectional area of the flow channel of the second filtering device.

As a specific embodiment of the present invention, the pushing structure has a length configured to be capable of pushing the powder cartridge across the bottle body into the upper lid or the bottom lid of the second container, and the upper lid or the lower lid is capable of receiving the powder cartridge.

Compared with the prior art, the technical solutions of the present invention have the following technical effects.

The coffee brewing apparatus of the present invention adopts the second filtering device with a permeability lower than that of the first filtering device to filter coffee, which improves the filtering precision and prevents coffee grounds from entering the coffee liquid to affect the taste; and meanwhile, the low permeability of the second filtering device improves the pressure when the coffee powder is in contact with water in the brewing process, which is beneficial to pressurization and infiltration to improve the concentration of the coffee. Meanwhile, the outer cup is provided with openings at two ends in the present invention, so that the problem that the powder cartridge is difficult to take out and place in from the same opening end after the second filtering device with a low permeability is adopted is solved.

### BRIEF DESCRIPTION OF THE DRAWINGS

FIG. 1 is a cross-sectional view of a detached structure of a portable coffee brewing apparatus according to one embodiment;

FIG. 2 is a cross-sectional view of first, second, and third containers of the portable coffee brewing apparatus in FIG. 1;

FIG. 3 is a schematic diagram of the use process of the portable coffee brewing apparatus in FIG. 1;

FIG. 4 is a cross-sectional view of a sealing connection structure between the bottle body and the upper and lower lids in FIG. 1;

FIG. 5 is a cross-sectional view of the powder cartridge in FIG. 1;

FIG. 6 is a schematic diagram of the structure of the second container of the portable coffee brewing apparatus of FIG. 1, in which the sealing connection structure is positioned at a bottom part of the second container;

FIG. 7 is a schematic diagram of the structure of a second container according to another embodiment, in which the sealing connection structure is positioned at a middle part of the second container;

FIG. 8 is a cross-sectional view of the powder cartridge and the pushing structure assembly in FIG. 1;

FIG. 9 is a cross-sectional view of a powder cartridge and a pushing structure assembly according to one embodiment;

FIG. 10 is a cross-sectional view of a powder cartridge and a pushing structure assembly according to one embodiment; and

FIG. 11 is a cross-sectional view of a powder cartridge and a pushing structure assembly according to one embodiment.

### DETAILED DESCRIPTION OF THE EMBODIMENTS

Embodiments of the present invention will be described in detail below, and examples of the embodiments are shown in the accompanying drawings, wherein the same or similar reference numerals indicate the same or similar elements or elements having the same or similar functions throughout. The embodiments described below with reference to the accompanying drawings are illustrative only for the purpose of explaining the present invention, and are not to be construed as limiting the present invention.

In the description of the present invention, it should be understood that directions or positional relationships indicated by terms “central”, “upper”, “lower”, “front”, “rear”, “left”, “right”, “vertical”, “horizontal”, “top”, “bottom”, “inner”, “outer” and the like are those shown based on the accompanying drawings, and are merely intended to facilitate and simplify description rather than indicate or imply that the indicated apparatus or element must have a specific direction and must be configured and operated according to the specific direction. Therefore, these directions or positional relationships should not be construed as limiting the present invention.

In embodiments, the sealing connection means that the joining surfaces of two connecting members are tightly closed to prevent the passage of fluids (e.g. water, and coffee).

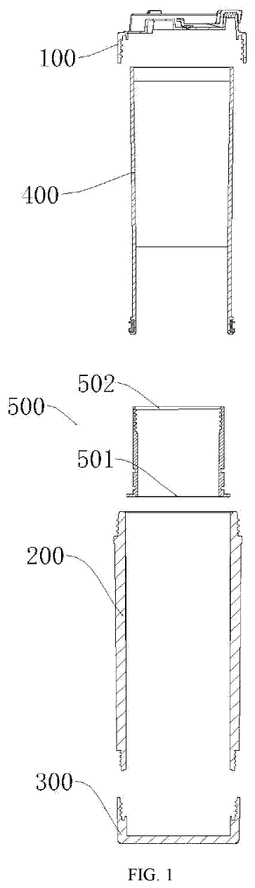

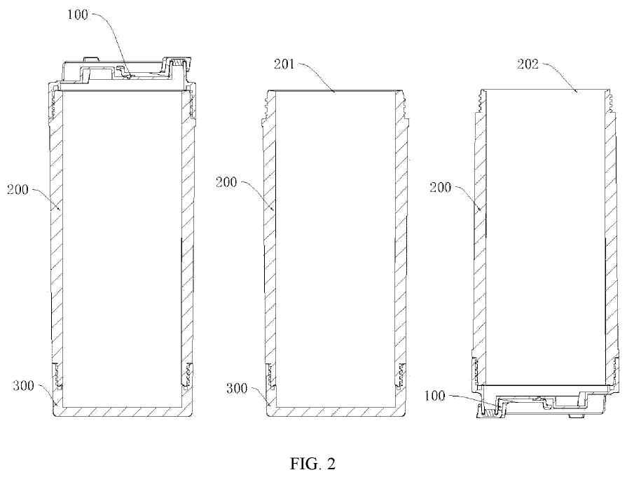

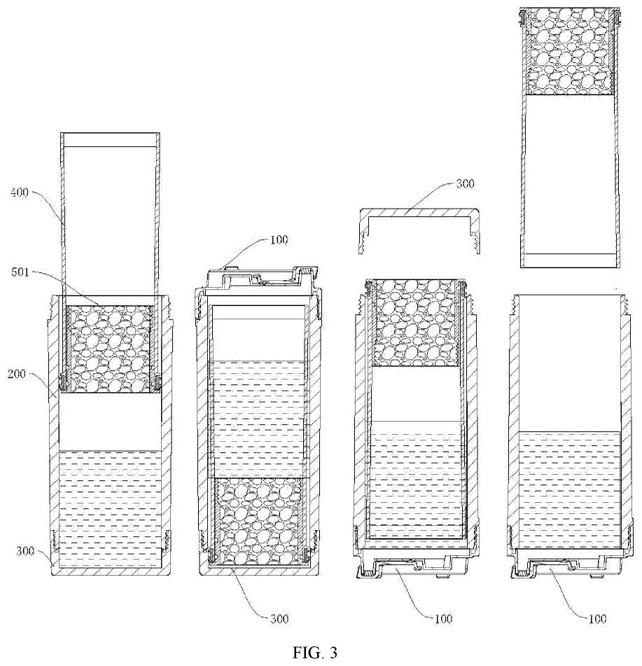

Referring to FIG. 1, a portable coffee brewing apparatus comprising an upper lid 100, a bottle body 200, a bottom lid 300, a pushing structure 400, and a powder cartridge 500 is shown, wherein the upper lid 100, the bottle body 200, and the bottom lid 300 are combined in different ways to form different containers capable of containing water; referring to FIG. 2, the bottle body 200 is a cylindrical structure with openings (201, 202) at two ends, the upper lid 100 and the bottom lid 300 are in sealing connection with the openings (201, 202) at two ends of the bottle body 200 in a detachable manner, respectively, after the connection, a first container (100, 200, 300) whose interior is completely isolated from the outside atmosphere is formed, and after the container is filled with water, there will be no water leakage when the container is rotated or turned upside down; a second container (200, 300) capable of containing water is formed after the upper lid 100 is detached from the first container (100, 200, 300), and the top part of the second container is provided with an opening 201; and a third container (100, 200) capable of containing water is formed after the bottom lid 300 is detached from the first container (100, 200, 300) that is turned upside down, and the top part of the third container is provided with an opening 202. The powder cartridge 500 is configured to store coffee powder, two ends of the powder cartridge 500 are provided with filtering devices (501, 502), the two filtering devices (501, 502) are a first filtering device 501 and a second filtering device 502, wherein the second filtering device 502 has a permeability lower than that of the first filtering device 501, and the pushing structure 400 is configured to push the powder cartridge 500 to move; when the coffee brewing apparatus of this embodiment is used, as shown in FIG. 3, the second container (200, 300) is filled with water (the water here may be hot or cold according to the type of configured coffee), then the powder cartridge 500 filled with the coffee powder is placed into the second container (200, 300) from the opening 201, when the powder cartridge is placed, the first filtering device 501 is positioned at the lower side of the second filtering device 502, after the power cartridge is placed, the outer peripheral sidewall of the powder cartridge 500 is in sealing connection with the inner peripheral sidewall of the second container (200, 300), the powder cartridge 500 is pushed to move to the bottom part of the second container (200, 300) by the pushing structure 400, and in this process, water flows through the first filtering device 501 and the second filtering device 502 in sequence and dissolves coffee powder in the powder cartridge 500; and since the second filtering device 502 has a permeability lower than that of the first filter screen 501, the second filtering device 502 has a throttling effect when the water passes through the powder cartridge 500, the contact pressure of the water and the coffee powder in the powder cartridge 500 may be improved to obtain strong coffee, and meanwhile the filtering precision of coffee grounds can also be improved. When the powder cartridge 500 reaches the bottom part of the second container (200, 300), the upper lid 100 is covered to form the first container (100, 200, 300), the first container (100, 200, 300) is turned upside down and the bottom lid 300 is detached to form the third container (100, 200), and the powder cartridge 500 is taken out from the opening 202 of the third container (100, 200). When the powder cartridge 500 is taken out, the amount of fluid above the powder cartridge 500 is small and no coffee is contained in this fluid, so that this operation of taking out the cartridge can be completed quickly, meanwhile, since the second filtering device 502 has a low permeability, when the powder cartridge 500 is taken out, one side of the second filtering device 502 that is in contact with coffee powder is communicated with the atmosphere to be in positive pressure, and the other side of the second filtering device is in negative pressure, which is beneficial for the liquid in the powder cartridge 500 to pass through the second filtering device 502, that is, the coffee grounds are further pressed dry to recover the coffee.

This coffee brewing apparatus adopts the second filtering device 502 with a permeability lower than that of the first filtering device 501 to filter, which improves the filtering precision and prevents coffee grounds from entering the coffee liquid to affect the taste; and meanwhile, the low permeability of the second filtering device 502 improves the pressure when the coffee powder is in contact with water in the brewing process, which is beneficial to pressurization and infiltration to improve the concentration of the coffee. Meanwhile, the detachable structure of the bottle body 200, the upper lid 100 and the lower lid 200 is provided, so that the moving distance and difficulty when the powder cartridge 500 is taken out are reduced, and the operation is simple.

In this coffee brewing apparatus, the first filtering device 501 may select a common filter screen, such as a 150-mesh plastic filter screen or a 200-mesh metal filter screen, in some embodiments, the second filtering device 502 may select a filter paper, and in other embodiments, the second filtering device 502 may select a dense metal filter screen with a larger number of meshes than those of the first filtering device 501, such as a 400-mesh metal filter screen.

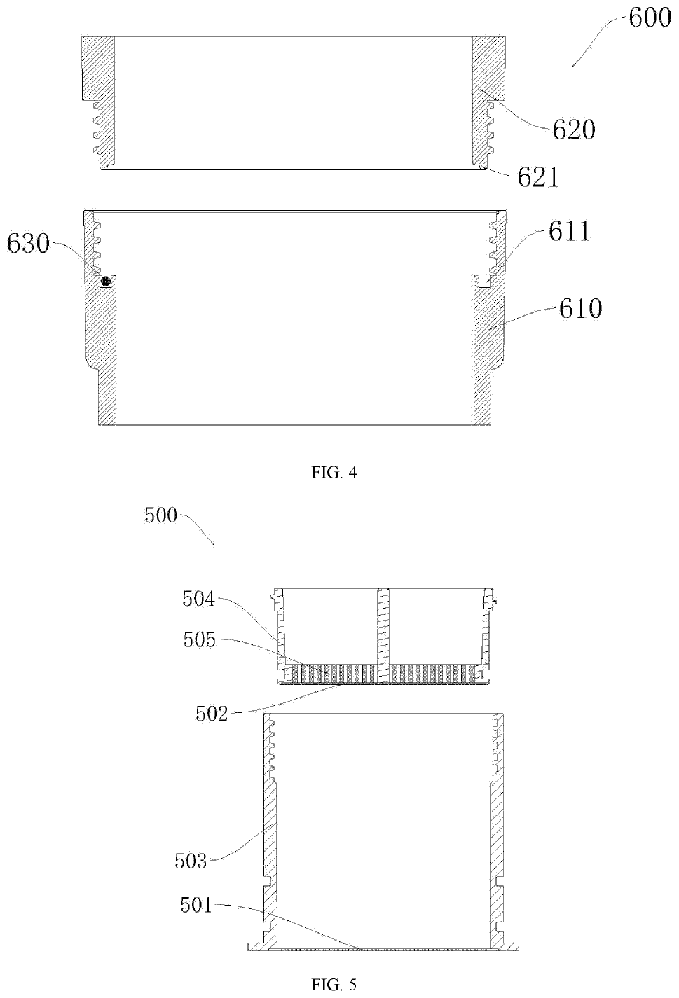

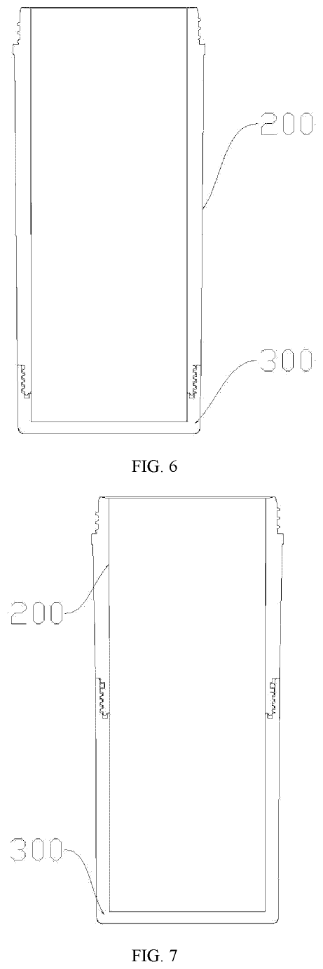

In this coffee brewing apparatus, the shape of the bottle body 200 may also be adjusted as needed, such as a square or a circle, the sealing connection structure 600 of the upper lid 100, the bottom lid 300 and the openings (201, 202) at two ends of the bottle body 200 may be selected as appropriate sealing manner from the prior art according to the shape of the bottle body 200 and the requirement of sealing performance, and the sealing connection structures at two ends are not necessarily the same, for example, when the bottle body 200 is cylindrical, the sealing manner is selected as screw connection, snap connection, and the like. In some embodiments of the present invention, the sealing connection structure as shown in FIG. 4 is adopted, this sealing connection structure 600 comprises a first cylinder section 610 and a second cylinder section 620 which are cylindrical, the inner wall of one end of the first cylinder section 610 is connected with the outer wall of one end of the second cylinder section 620 threadedly, end surfaces of opposite ends of both the first cylinder section 610 and the second cylinder section 620 are provided with annular grooves 611 and bosses 621, and the grooves 611 are matched with the bosses 621, so that the bosses 621 are inserted into and in pressing contact with the grooves 611 after the first cylinder section 610 and the second cylinder section 620 are connected, and the area of the sealing surface is increased. In addition, annular sealing gaskets 630 also may be placed in the grooves 611 to further enhance the sealing performance, and in specific manufacturing, the first cylinder section 610 and the second cylinder section 620 are fixedly connected with two cylinder sections which need to be in sealing connection, for example, the first cylinder section 610 and the second cylinder section 620 are integrally formed with the bottom lid 300 and the bottle body 200, respectively. In addition, the relative height of the bottle body 200 and the bottom lid 300 may be selected as needed, as shown in FIG. 6, the sealing connection structure 600 is positioned at the bottom part of the second container (200, 300) in some embodiments, as shown in FIG. 7, the sealing connection structure 600 is positioned at the middle part of the second container (200, 300) in other embodiments, and when the sealing connection structure 600 is positioned at the middle part, the powder cartridge 500 is detached together with the bottom lid 300 after the bottom lid 300 of the first container (100, 200, 300) is detached, so that the problem of taking out the powder cartridge later is avoided.

In the coffee brewing apparatus of the present invention, the powder cartridge 500 is configured to contain coffee powder, and in the use process, coffee powder needs to be placed into the powder cartridge 500 and coffee grounds need to be taken out from the powder cartridge, therefore, in some embodiments, the powder cartridge 500 is configured into a detachable structure, as shown in FIG. 5, the powder cartridge 500 comprises a cartridge body 503, a pressing lid 504, and filtering devices (501, 502), the cartridge body 503 is of a cylindrical structure with openings at two ends, the filtering devices (501, 502) are a second filtering device 502 and a first filtering device 501, the first filtering device 501 is installed at the opening end of the lower part of the cartridge body 503, the second filtering device 502 is installed on the pressing lid 504, the pressing lid 504 is connected with the opening end of the upper part of the cartridge body 503 threadedly, and after the pressing lid 504 is detached, coffee powder is placed into the powder cartridge 500 or coffee grounds are taken out from the powder cartridge. In some embodiments, where the second filtering device adopts a filter paper, the second filtering device 502 itself has a poor rigidity, therefore, a sieve plate 505 is provided on the pressing lid 504 to support the second filtering device 501, and the second filtering device 502 is integrally attached to the sieve plate 505. In other embodiments, the cartridge body 503 and the pressing lid 504 may adopt snap connection.

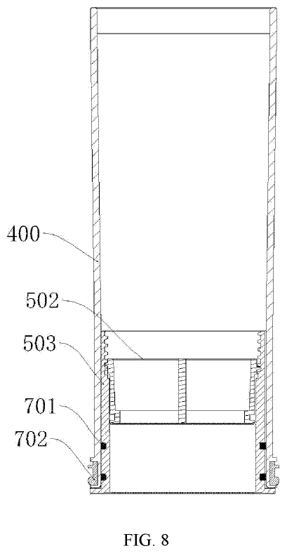

In some embodiments of the present invention, the pushing structure 400 is an inner cup, as shown in FIG. 8, the inner cup is of a cylindrical structure with openings at two ends, the powder cartridge 500 is coaxially sleeved in the inner cup, and one end of the inner cup is communicated with one end of the powder cartridge 500 provided with the second filtering device 502; the outer peripheral sidewall of the cartridge body 503 is provided with a first sealing ring 701 to seal an annular gap between the powder cartridge 500 and the inner peripheral sidewall of the inner cup; and the outer peripheral sidewall of the inner cup is provided with a second sealing ring 702 to seal an annular gap between the outer peripheral sidewall of the inner cup and the inner peripheral sidewall of the second container (200, 300).

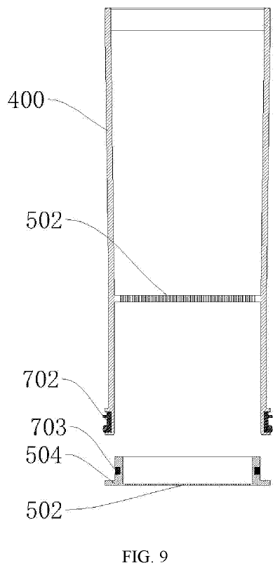

In some embodiments of the present invention, the pushing structure 400 is an inner cup, the inner cup is of a cylindrical structure with openings at two ends, as shown in FIG. 9, the cartridge body 503 is integrally formed with the inner cup, the second filtering device 502 is fixed in the inner cup, the first filtering device 501 is fixed on the pressing lid 504, the pressing lid 504 is connected with the inner cup in a detachable manner, and a third sealing ring 703 is provided on the pressing lid 504 to seal an annular gap between the pressing lid 504 and the inner cup.

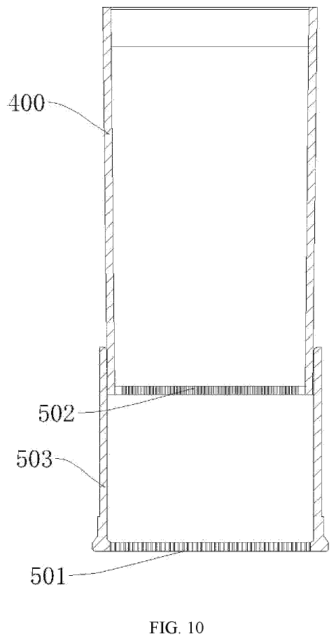

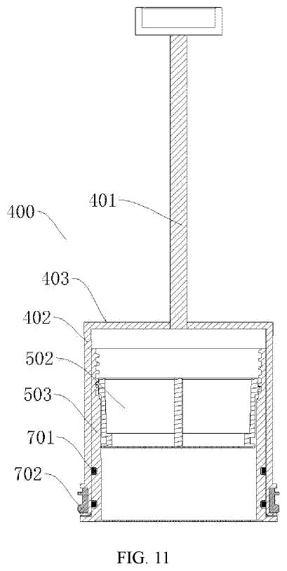

In some embodiments of the present invention, the pushing structure 400 comprises an inner cup, the inner cup is of a cylindrical structure with openings at two ends, as shown in FIG. 10, the cartridge body 503 is of a cylindrical structure, the peripheral sidewall of the cartridge body is made of an elastic material, such as soft rubber or elastic rubber, one end of the cartridge body 503 is sleeved on the peripheral sidewall of the inner cup, and the peripheral sidewall of the cartridge body 503 has a deformation capability, so that when the cartridge body is placed into the second container (200, 300), the annular gap between the peripheral sidewall of the inner cup and the second container (200, 300) can be sealed. The two ends of the cartridge body 503 are provided with the first filtering device 501 and the second filtering device 502, wherein the second filtering device 501 may be integrally formed with the inner cup, the first filtering device 501 may be fixedly connected with the cartridge body 503, when the cartridge body 503 is along the bottom part of the second container (200, 300), the cartridge body 503 is further pushed by the inner cup, then the cartridge body 503 is deformed to reduce the volume inside the powder cartridge 500, and the coffee inside the powder cartridge 500 is squeezed, which is beneficial to press coffee grounds and reduce the water content. In other embodiments, the cartridge body 503 may be of a cylindrical structure without a lid, and through holes are provided on the bottom lid of the closed section of the cartridge body to penetrate through the cartridge body, so as to form the filtering device 501.

In some embodiments of the present invention, the pushing structure 400 comprises a pressing rod 401 and an annular body 402, as shown in FIG. 9, the annular body 402 is of a cylindrical structure with openings at two ends, the upper portion of the annular body is connected with the pressing rod 401 through a supporting rod 403, the powder cartridge 500 is coaxially sleeved in the annular body 402, one end of the annular body 402 is communicated with one end of the second filtering device 502 provided with the powder cartridge 500, the outer peripheral sidewall of the powder cartridge body 503 is provided with a first sealing ring 701 to seal an annular gap between the powder cartridge 500 and the inner peripheral sidewall of the annular body 402; and the outer peripheral sidewall of the annular body 402 is provided with a second sealing ring 702 to seal an annular gap between the outer peripheral sidewall of the annular body 402 and the inner peripheral sidewall of the second container (200, 300).

Although the embodiments of the present invention have been shown and described, it may be understood by those of ordinary skill in the art that various changes, modifications, substitutions, and alterations may be made to these embodiments without departing from the principle and purpose of the present invention, and the scope of the present invention is defined in the claims and equivalents thereof.

What is claimed is:

1. A portable coffee brewing apparatus, comprising:
a bottle body, wherein the bottle body is of a structure with openings at two ends;
an upper lid;
a bottom lid;
wherein the upper lid and the bottom lid are in sealing connection with the two ends of the bottle body in a detachable manner, and a first container configured to contain water is formed after the connection; a second container configured to contain water is formed after one of the upper lid and the bottom lid is detached from the first container, and a third container configured to contain water is formed after the other one of the upper lid and the bottom lid is detached from the first container;
a powder cartridge, wherein the powder cartridge is configured to store coffee powder, two ends of the powder cartridge are provided with filtering devices which are a first filtering device and a second filtering device, and the second filtering device has a permeability lower than that of the first filtering device; when the powder cartridge is placed in from an opening of the second container and taken out from an opening of the the third container, the powder cartridge is in sealing connection with peripheral sidewalls of the second container and the third container; and
a pushing structure, wherein the pushing structure is configured to push the powder cartridge to move in the second container, and the second filtering device is arranged downstream of the first filtering device in the process of placing the powder cartridge into the second container.

2. The portable coffee brewing apparatus according to claim 1, wherein the second filtering device is a filter paper.

3. The portable coffee brewing apparatus according to claim 1, wherein the second filtering device is a filter screen.

4. The portable coffee brewing apparatus according to claim 1, wherein the pushing structure is connected with the powder cartridge in a detachable manner.

5. The portable coffee brewing apparatus according to claim 3, wherein the pushing structure is an inner cup, the inner cup is of a cylindrical structure with openings at two ends, one end of the inner cup is communicated with one end of the powder cartridge provided with the second filtering device, and an outer peripheral sidewall of the inner cup is in sliding and sealing connection with an inner peripheral sidewall of an outer cup.

6. The portable coffee brewing apparatus according to claim 3, wherein the pushing structure comprises an inner cup, the inner cup is of a cylindrical structure with openings at two ends, the powder cartridge comprises a cartridge body made of an elastic material, the cartridge body is of a cylindrical structure with one end sleeved on an outer wall of one end of the inner cup, and when the inner cup is positioned in the second container and the third container, a part of the cartridge body sleeved on an outer wall of the inner cup seals an annular gap between the inner cup and the second container and the third container.

7. The portable coffee brewing apparatus according to claim 1, wherein a sealing structure in which the upper lid or the bottom lid is connected with the bottle body comprises a first cylinder section and a second cylinder section which are both cylindrical, an inner wall of one end of the first cylinder section is coaxially connected with an outer wall of one end of the second cylinder section threadedly, end surfaces of opposite ends of both the first cylinder section and the second cylinder section are provided with annular grooves and bosses, and the grooves are matched with the bosses, so that the bosses are inserted into and in pressing contact with the grooves after the first cylinder section and the second cylinder section are connected.

8. The portable coffee brewing apparatus according to claim 7, wherein the grooves are provided with sealing gaskets.

9. The portable coffee brewing apparatus according to claim 1, wherein the powder cartridge comprises a cylindrical cartridge body and a pressing lid, and the pressing lid is connected with one end of the cartridge body in a detachable manner.

10. The portable coffee brewing apparatus according to claim 9, wherein one end of the pressing lid is provided with a sieve plate configured to support the second filtering device.

11. The portable coffee brewing apparatus according to claim 1, wherein the pushing structure has a length configured to push the powder cartridge across the bottle body into the upper lid or the bottom lid of the second container, and the upper lid or the lower lid is capable of receiving the powder cartridge.
